(19) United States
(12) Patent Application Publication
(10) Pub. No.: US 2025/0343683 A1
(43) Pub. Date: Nov. 6, 2025

(54) PASSKEY MANAGEMENT METHOD FOR MULTI-PLATFORM ENVIRONMENT, AND APPARATUS FOR IMPLEMENTING THE SAME

(71) Applicant: SAMSUNG SDS CO., LTD., Seoul (KR)

(72) Inventors: Hong Chul LEE, Seoul (KR); Dong Ho KIM, Seoul (KR); Si Wan BAE, Seoul (KR)

(73) Assignee: SAMSUNG SDS CO., LTD., Seoul (KR)

(21) Appl. No.: 19/189,626

(22) Filed: Apr. 25, 2025

(30) Foreign Application Priority Data
May 2, 2024 (KR) 10-2024-0058628

(51) Int. Cl. H04L 9/08; H04L 9/32

(52) U.S. Cl. CPC H04L 9/0861; H04L 9/32

(57) ABSTRACT

The present disclosure according to at least one embodiment provides a passkey management method for a multi-platform environment, the method being performed by a computing device. The method comprises in response to receipt of a passkey generation request from a passkey agent installed on a first terminal based on a first platform, generating a first passkey usable on multiple platforms, and transmitting the first passkey to the first terminal, in response to receipt of a passkey list request from a passkey agent installed on a second terminal based on a second platform, different from the first platform, providing information regarding a registered passkey list to the second terminal, and in response to receipt of a request for the first passkey, among passkeys included in the registered passkey list, from the passkey agent of the second terminal, transmitting the first passkey to the second terminal.

### CROSS-REFERENCE TO RELATED APPLICATION

This application claims priority from Korean Patent Application No. 10-2024-0058628 filed on May 2, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a passkey management method for a multi-platform environment and an apparatus for implementing the same, and more particularly, to a passkey management method for a multi-platform environment and an apparatus for implementing the same, which provide a management service enabling a passkey registered through a specific platform to be used on other platforms.

### 2. Description of the Related Art

Conventional password-based user authentication has the drawback that passwords can be easily forgotten, require periodic changes, and are vulnerable to security threats.

To address the problems associated with password-based user authentication methods, there is increasing interest in passkey services, which offer passwordless user account authentication through Fast Identity Online (FIDO), a more convenient alternative.

With passkeys, user authentication for websites or platform-specific applications requiring user registration and login can be easily performed without passwords, using biometric authentication methods such as fingerprint recognition or PIN entry.

However, currently, each platform only provides features to view or delete passkeys through its own management screen, and allows for management of only the passkeys registered thereon, thereby limiting functionality.

Furthermore, a current passkey management system provided by each platform allows only the viewing and deletion of passkeys registered on the corresponding platform, making it impossible to even view passkeys registered on other platforms.

One of the advantages of passkeys is that once a user account is registered on an application or website, the user can log in through authentication without needing to re-register. However, the current management system provided by each platform only supports managing passkeys registered through that platform. To use a passkey across multiple platforms, it must be re-registered, which is inconvenient.

Additionally, since each platform provides a separate settings screen, users must familiarize themselves with how to use each individual platform in order to manage their passkeys, which is also inconvenient.

Therefore, there is a need for a technology that enables passkeys registered on a specific platform to be used across all platforms without platform limitations.

In addition, there is a need to provide an integrated management function that allows users to view and delete passkeys registered on different platforms through a single screen.

### SUMMARY

An objective of the present disclosure is to provide a passkey management method for a multi-platform environment and an apparatus for implementing the same, which enable a passkey generated on one platform to be used for user authentication on another platform.

Another objective of the present disclosure is to provide a passkey management method for a multi-platform environment and an apparatus for implementing the same, which offer a passkey synchronization function that allows a passkey registered on one platform to be used on another platform without the need for re-registration.

Yet another objective of the present disclosure is to provide a passkey management method for a multi-platform environment and an apparatus for implementing the same, which offer an integrated management function that allows passkeys registered on different platforms to be viewed and deleted through a single screen.

Still another objective of the present disclosure is to provide a passkey management method for a multi-platform environment and an apparatus for implementing the same, which offer an option that allows each registered passkey to be set as available either for a single platform or for multiple platforms.

The objectives of the present disclosure are not limited to those mentioned above, and other objectives not explicitly stated will be clearly understood by those skilled in the art based on the following description.

According to an aspect of the present disclosure, there is provided a passkey management method for a multi-platform environment, the method being performed by a computing device. The method comprises in response to receipt of a passkey generation request from a passkey agent installed on a first terminal based on a first platform, generating a first passkey usable on multiple platforms, and transmitting the first passkey to the first terminal, in response to receipt of a passkey list request from a passkey agent installed on a second terminal based on a second platform, different from the first platform, providing information regarding a registered passkey list to the second terminal, and in response to receipt of a request for the first passkey, among passkeys included in the registered passkey list, from the passkey agent of the second terminal, transmitting the first passkey to the second terminal.

In some embodiments, the first and second platforms may be different OS platforms.

In some embodiments, the generating and transmitting of the first passkey may comprise receiving the passkey generation request from the passkey agent of the first terminal upon completion of user authentication by the passkey agent of the first terminal in response to a login request from a first service application installed on the first terminal.

In some embodiments, the providing of the information regarding the registered passkey list may comprise receiving the passkey list request from the passkey agent of the second terminal upon completion of user authentication by the passkey agent of the second terminal in response to a login request from the first service application installed on the second terminal.

In some embodiments, the providing of the information regarding the registered passkey list may comprises providing, to the passkey agent of the second terminal, information indicating whether each of the passkeys included in the registered passkey list is for multi-platform use or for specific platform use.

In some embodiments, the providing of the information regarding the registered passkey list may comprise providing, to the passkey agent of the second terminal, information indicating whether each of the passkeys included in the registered passkey list is in a synced state or a desynced state.

In some embodiments, the providing of the information indicating whether each of the passkeys included in the registered passkey list is in the synced state or the desynced state, may comprise providing additional information indicating a synchronization status of each passkey usable on both the first and second platforms.

In some embodiments, the providing of the information indicating whether each of the passkeys included in the registered passkey list is in the synced state or the desynced state may comprise providing additional information indicating that each passkey that is exclusive to Windows OS or usable only on the first platform is in the desynced state.

In some embodiments, the method further may comprises: providing information regarding the registered passkey list to the first terminal, receiving, from the passkey agent of the first terminal, a deletion request for a second passkey among the passkeys included in the registered passkey list, updating the registered passkey list by deleting the second passkey, and providing information regarding the updated passkey list to the second terminal.

According to another aspect of the present disclosure, there is provided a passkey management method for a multi-platform environment, the method being performed by a computing device. The method comprises in response to receipt of information regarding a first passkey that has been generated and registered by a first terminal based on a first platform, updating a registered passkey list using the information regarding the first passkey, and in response to receipt of a passkey list request from a passkey agent installed on a second terminal based on a second platform, different from the first platform, providing information regarding the updated passkey list to the second terminal.

In some embodiments, the first platform may be Windows OS, and the second platform may be an OS platform different from the Windows OS.

In some embodiments, the providing of the information regarding the updated passkey list may comprise providing, to the passkey agent of the second terminal, information indicating whether each passkey included in the updated passkey list is for multi-platform use or for specific platform use.

In some embodiments, the providing of the information regarding the updated passkey list may comprise providing, to the passkey agent of the second terminal, information indicating whether each passkey included in the updated passkey list is in a synced state or a desynced state.

In some embodiments, the method may further comprise: checking, at intervals of a predefined time period, whether each passkey included in the updated passkey list is in an unused state, if the checking result shows that the first passkey is in the unused state, updating the registered passkey list by deleting the information regarding the first passkey from the passkey list, and providing information regarding the updated passkey list to the passkey agent of the second terminal.

In some embodiments, the method may further comprises: transmitting a push notification of a deletion result of the first passkey to the passkey agent of the second terminal.

According to another aspect of the present disclosure, there is provided a passkey management method for a multi-platform environment, the method being performed by a user terminal based on a second platform. The method comprises: receiving, from a first terminal based on a first platform different from the second platform, a passkey authentication request in response to a user's login request, executing a passkey agent installed on the user terminal to determine whether the user's passkey has been previously registered, and if the user's passkey is determined to have been previously registered, transmitting an authentication result of the user's passkey to the first terminal.

In some embodiments, the first platform may Windows OS, and the second platform may be an OS platform different from the Windows OS.

In some embodiments, the receiving of the passkey authentication request from the first terminal may comprise receiving a user authentication request and the passkey authentication request in response to the user's login request for a specific website via a browser installed on the first terminal.

In some embodiments, the transmitting of the authentication result of the user's passkey to the first terminal may comprise, if user authentication and passkey authentication for the user are successfully performed, transmitting the authentication result of the user's passkey to the first platform.

According to another aspect of the present disclosure, there is provided a computing device. The computing device comprises at least one processor, a memory that loads a computer program executed by the at least one processor, and a storage that stores the computer program, wherein the computer program includes instructions for performing operations of: in response to receipt of a passkey generation request from a passkey agent installed on a first terminal based on a first platform, generating a first passkey usable on multiple platforms and transmitting the first passkey to the first terminal; in response to receipt of a passkey list request from a passkey agent installed on a second terminal based on a second platform, different from the first platform, providing information regarding a registered passkey list to the second terminal; and in response to receipt of a request for the first passkey, among passkeys included in the registered passkey list, from the passkey agent of the second terminal, transmitting the first passkey to the second terminal.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments in detail with reference to the attached drawings, in which:

FIG. 1 is a block diagram illustrating the configuration of a system for providing a passkey management service for a multi-platform environment according to an embodiment of the present disclosure;

FIG. 2 is a flowchart illustrating a passkey management method for a multi-platform environment according to an embodiment of the present disclosure;

FIG. 3 is a flowchart illustrating steps that may be additionally performed after the steps illustrated in FIG. 2;

FIG. 4 is a flowchart illustrating a passkey management method for a multi-platform environment according to another embodiment of the present disclosure;

FIG. 5 is a flowchart illustrating steps that may be additionally performed after the steps illustrated in FIG. 4;

FIG. 6 is a flowchart illustrating a passkey management method for a multi-platform environment according to yet another embodiment of the present disclosure;

FIG. 7 illustrates a process of providing a passkey management service for terminals based on different platforms, with reference to FIG. 2;

FIG. 8 illustrates the effect of the process illustrated in FIG. 7;

FIG. 9 illustrates a process in which, in response to a request from a Windows OS-based terminal, a passkey authentication result is provided from a terminal based on another platform, with reference to FIG. 6;

FIG. 10 illustrates the effect of the process illustrated in FIG. 9;

FIG. 11 illustrates an exemplary management screen interface provided by a passkey agent according to some embodiments of the present disclosure;

FIG. 12 illustrates a process of registering and sharing a passkey across different platforms according to some embodiments of the present disclosure;

FIG. 13 illustrates a process of registering and sharing a passkey between a Windows platform and another platform according to some embodiments of the present disclosure;

FIG. 14 illustrates a process of deleting a passkey and updating the passkey list across different platforms according to some embodiments of the present disclosure;

FIG. 15 illustrates a process of deleting a passkey and updating the passkey list between a Windows platform and another platform according to some embodiments of the present disclosure; and

FIG. 16 is a hardware configuration diagram of an exemplary computing device capable of implementing methods according to embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

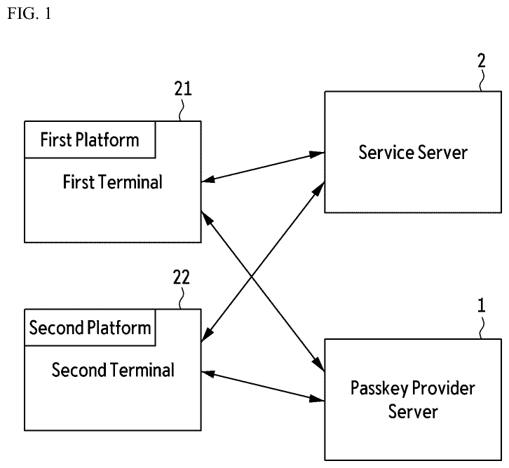

FIG. 1 is a block diagram illustrating the configuration of a system for providing a passkey management service for a multi-platform environment according to an embodiment of the present disclosure.

Referring to FIG. 1, the system includes a passkey provider server 1, a service server 2, the first terminal 21 based on the first platform, and the second terminal 22 based on the second platform. The first and second terminals 21 and 22 are connected to the passkey provider server 1 and the service server 2 via a network.

Each of the first and second terminals 21 and 22 is a user terminal on which a passkey agent is installed, the passkey agent providing a passkey service usable for logging into a website or application. The first and second terminals 21 and 22 may be, for example, mobile terminals such as smartphones or tablets, or PCs.

The first and second terminals 21 and 22, based on the first and second platforms, respectively, may be terminals based on different OS platforms such as Android, IOS, Windows, or macOS, and various OS platforms may be applicable without limitation to the type of OS.

The service server 2, which is a device that provides data and executable files required for a service application installed on each of the first and second terminals 21 and 22, may be, for example, an application server, a cloud server, or a virtual server.

The passkey provider server 1, which is a device that receives and processes a passkey generation request or a passkey authentication request from each of the first and second terminals 21 and 22, may also be an application server, a cloud server, or a virtual server.

In response to a login request from the service application or website on the first terminal 21, the passkey provider server 1 receives a passkey generation request from the passkey agent installed on the first terminal 21.

In response to the received passkey generation request, the passkey provider server 1 newly generates a first passkey and transmits it to the first terminal 21, and the transmitted first passkey is verified and stored in secure space on the first terminal 21.

Meanwhile, in response to a login request from the service application or website on the second terminal 22, the passkey provider server 1 receives a passkey list request from the passkey agent installed on the second terminal 22.

Here, the first and second platforms are different OS platforms, and the same service application may be installed on both the first and second terminals 21 and 22.

Also, the same passkey agent may be installed on both the first and second terminals 21 and 22, providing the same passkey service, although the version installed on each of the first and second terminals 21 and 22 may be specific to the corresponding OS platform.

In response to receipt of the passkey list request from the passkey agent of the second terminal 22, the passkey provider server 1 provides information regarding a pre-registered passkey list to the second terminal 22.

Subsequently, among the passkeys included in the registered passkey list, the passkey agent of the second terminal 22 may send a request for the first passkey that has been newly registered in response to the passkey generation request from the first terminal 21 to the passkey provider server 1.

In this case, the passkey provider server 1 may identify the first passkey from the registered passkey list and transmit it to the second terminal 22.

According to the configuration of the system described above, it is possible to provide a passkey management service that supports a multi-platform environment, enabling user authentication using the same passkey across multiple platforms, even when the passkey has been generated on only one of the platforms.

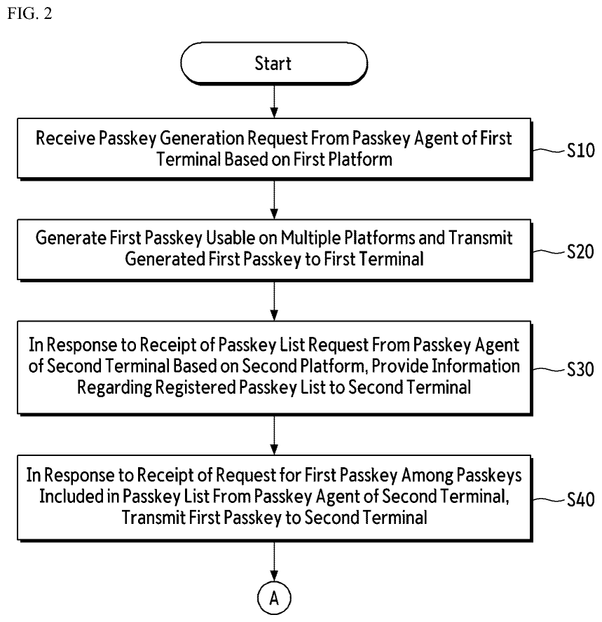

FIG. 2 is a flowchart illustrating a passkey management method for a multi-platform environment according to an embodiment of the present disclosure.

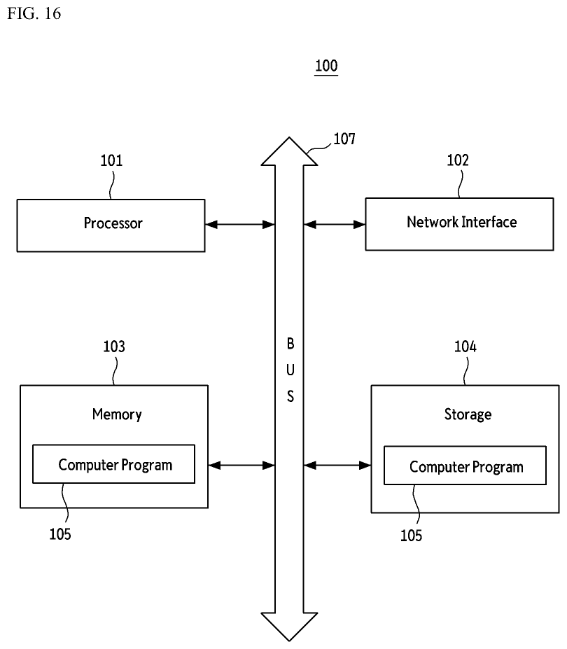

The passkey management method according to an embodiment of the present disclosure may be executed by the passkey provider server 1 illustrated in FIG. 1 or by a computing device 100 illustrated in FIG. 16. The computing device 100 executing the passkey management method according to an embodiment of the present disclosure may be a computing device equipped with an application program execution environment. The computing device 100 may be, for example, an application server, a cloud server, or a virtual server.

Descriptions of a subject entity that performs some operations or steps included in the passkey management method according to an embodiment of the present disclosure may be omitted. In such cases, the subject entity is to be understood as the computing device 100.

In providing a passkey management service, the passkey management method according to an embodiment of the present disclosure may provide a viewing and sharing function that enables passkeys registered on different platforms to be used across all platforms without platform limitations.

Referring to FIG. 2, in response to receipt of a passkey generation request from the passkey agent installed on a first terminal 21 based on a first platform, in step S10, the computing device 100 generates a first passkey usable on multiple platforms and transmits the first passkey to the first terminal 21 in step S20.

Specifically, the computing device 100 may receive the passkey generation request from the passkey agent of the first terminal 21 after user authentication by the passkey agent is complete in response to a login request from a first service application installed on the first terminal 21.

Thereafter, in step S30, in response to receipt of a passkey list request from the passkey agent installed on a second terminal 22 based on a second platform different from the first platform, the computing device 100 provides information regarding the registered passkey list to the second terminal 22. Here, the first and second platforms may be different OS platforms. For example, the first platform may be Android, and the second platform may be iOS.

Specifically, the computing device 100 may receive the passkey list request from the passkey agent of the second terminal 22 after user authentication by the passkey agent is complete in response to a login request from the same service application installed on the second terminal 22.

In one embodiment, when providing the information regarding the registered passkey list to the second terminal 22, the computing device 100 may also provide information indicating whether each passkey included in the registered passkey list is usable for multiple platforms or for a specific platform. Additionally, the computing device 100 may further provide information indicating whether each passkey in the registered passkey list is in a synced state or a desynced state.

Thereafter, in step S40, in response to receipt of a request for the first passkey among the passkeys included in the registered passkey list from the passkey agent of the second terminal 22, the computing device 100 transmits the first passkey to the second terminal 22.

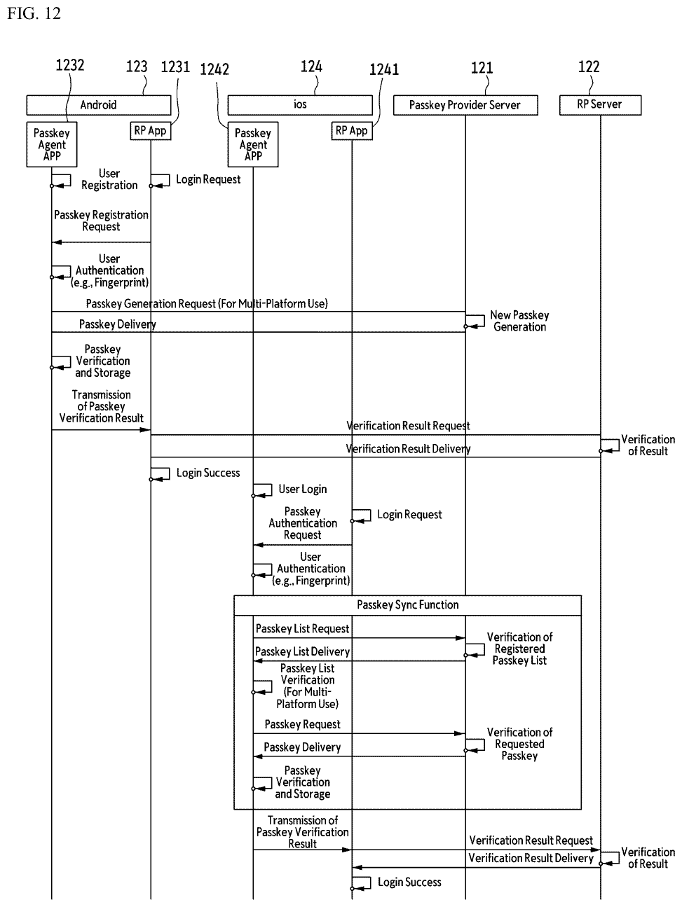

As a specific example, referring to FIG. 12, when there is a login request from a Relying Party (RP) application 1231 after user registration in a passkey agent 1232 on an Android-based first terminal 123, a passkey registration request is transmitted to the passkey agent 1232.

Accordingly, the passkey agent 1232 performs user authentication through biometric recognition such as fingerprint recognition and sends a request for generating a multi-platform passkey to the passkey provider server 121.

The passkey provider server 121 generates a multi-platform passkey and transmits the generated passkey to the passkey agent 1232, and the passkey agent 1232 verifies and stores the received passkey and transmits the passkey verification result to an RP server 122 for verification.

The RP application 1231 of the first terminal 123 receives the verification result from the RP server 122, and login is successfully performed accordingly.

Meanwhile, on an iOS-based second terminal 124, when there is a login request from an RP application 1241 after user login in a passkey agent 1242, a passkey authentication request is transmitted to the passkey agent 1242.

Accordingly, the passkey agent 1242 performs user authentication through biometric recognition such as fingerprint recognition and transmits a passkey list request to the passkey provider server 121.

The passkey provider server 121 transmits a passkey list including pre-registered passkeys to the passkey agent 1242 of the second terminal 124, and the passkey agent 1242 identifies a multi-platform passkey from the received passkey list and sends a request for the identified passkey to the passkey provider server 121.

The passkey agent 1242 receives the multi-platform passkey from the passkey provider server 121, verifies and stores the received passkey, and transmits the passkey verification result to the RP server 122 for verification. The RP application 1241 of the second terminal 124 receives the verification result from the RP server 122, and login is successfully performed accordingly.

According to the aforementioned embodiment, by registering a multi-platform passkey on one OS platform, the passkey can be shared through a synchronization function, enabling its use not only on the OS platform where it has been registered but also on other OS platforms.

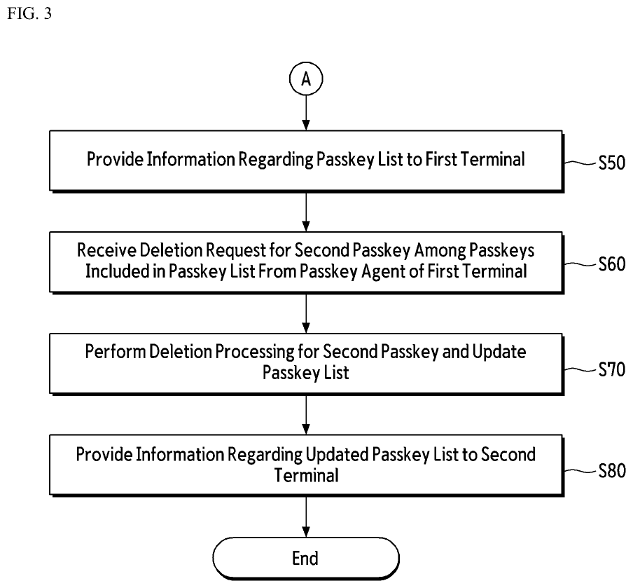

In one embodiment, referring to FIG. 3, after performing steps S10, S20, S30, and S40 of FIG. 2, the computing device 100 may additionally perform steps S50, S60, S70, and S80.

In step S50, the computing device 100 may provide information regarding the

registered passkey list to the first terminal 21. In step S60, the computing device 100 may receive a deletion request for a second passkey, among the passkeys included in the registered passkey list, from the passkey agent of the first terminal 21.

Then, in step S70, the computing device 100 deletes the second passkey from the registered passkey list and updates the passkey list accordingly.

Thereafter, in step S80, the computing device 100 may provide information regarding the updated passkey list to the second terminal 22.

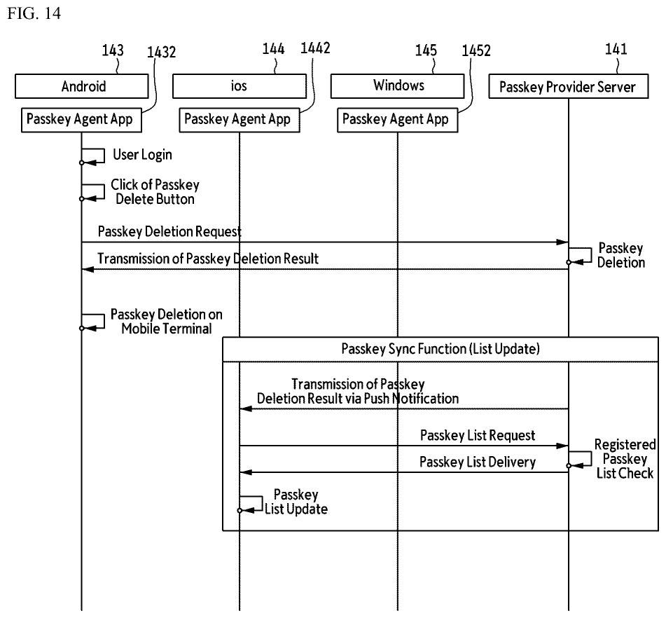

As a specific example, referring to FIG. 14, on an Android-based first terminal 143, after user login in a passkey agent 1432, when a delete button for a specific passkey is clicked in the passkey list displayed on the management screen of a passkey agent 1432, a deletion request for the specific passkey is transmitted to the passkey provider server 121.

The passkey provider server 121 performs deletion processing for the specific passkey requested to be deleted from the registered passkey list and transmits the passkey deletion result to the passkey agent 1432.

In response to receipt of the passkey deletion result, the passkey agent 1432 of the first terminal 143 deletes the specific passkey stored in the secure space of the first terminal 143.

Meanwhile, as the specific passkey is deleted from the registered passkey list, the passkey provider server 121 also transmits the passkey deletion result to an iOS-based second terminal 144 as a push notification.

At this time, when a passkey agent 1442 of the second terminal 144 sends a passkey list request to the passkey provider server 121, the passkey provider server 121 transmits the updated passkey list reflecting the deletion of the specific passkey to the passkey agent 1442. Accordingly, the passkey agent 1442 displays the updated passkey list.

According to the aforementioned embodiment, when passkeys are registered or deleted on different platforms, the passkey list can be updated to reflect such changes and provided accordingly.

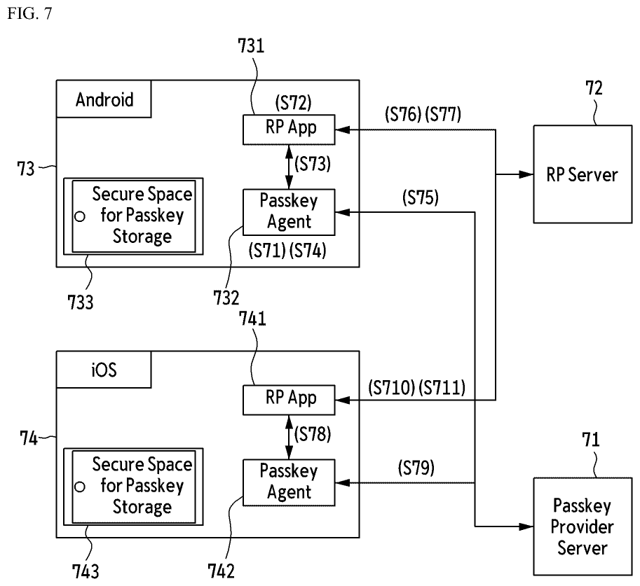

FIG. 7 illustrates a process of providing a passkey management service for terminals based on different platforms, with reference to FIG. 2.

Referring to FIG. 7, when user registration is completed in a passkey agent 732 installed on an Android-based first terminal 73 (S71), and a login attempt is made by a user through an RP application 731 (S72), the RP application 731 sends a passkey registration request to the passkey agent 732 (S73).

The passkey agent 732 performs user authentication through biometric recognition, such as fingerprint or iris recognition (S74), and sends a passkey generation request for generation of a multi-platform passkey to a passkey provider server 71 (S75).

The passkey agent 732 of the first terminal 73 receives a multi-platform passkey generated by the passkey provider server 71 in response to the passkey generation request, verifies the received passkey, stores it in secure space 733, and sends the passkey verification result to an RP server 72 (S76).

When the RP server 72 verifies the passkey verification result, login to the RP application 731 is successfully performed on the first terminal 73 (S77).

Thereafter, when a login attempt is made by the same user through an RP application 741, which is the same as the RP application 731, on an iOS-based second terminal 74 (S78), a passkey agent 742 of the second terminal 74 sends a request to the passkey provider server 71 to acquire the user's passkey (S79). Here, the requested passkey may be the multi-platform passkey previously generated by the first terminal 73 and may be set to a synced state so as to be usable on both Android and iOS platforms. The synchronization state of the requested multi-platform passkey may be identified from the passkey list displayed on the management screen of the passkey agent 742.

The passkey provider server 71 identifies the requested multi-platform passkey in the synced state in the registered passkey list and transmits it to the passkey agent 742 of the second terminal 74.

Accordingly, the passkey agent 742 of the second terminal 74 receives and verifies the multi-platform passkey, stores it in secure space 743, and transmits the passkey verification result to the RP server 72 (S710).

When the RP server 72 verifies the received passkey verification result, login to the RP application 741 is successfully performed on the second terminal 74 (S711).

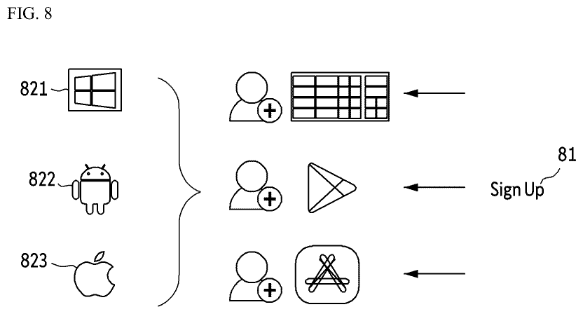

According to the aforementioned embodiment, as illustrated in FIG. 8, once the user signs up for a multi-platform passkey on one OS platform, as indicated by reference numeral 81, the same passkey can be used without re-registration on various OS platforms such as Windows OS 821, Android 822, and iOS 823.

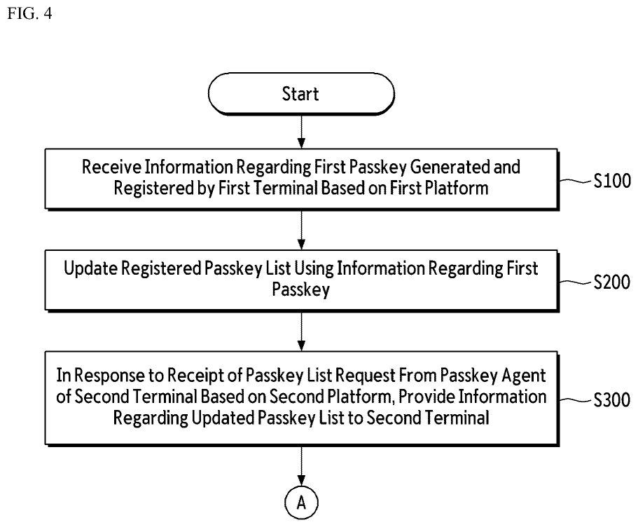

FIG. 4 is a flowchart illustrating a passkey management method for a multi-platform environment according to another embodiment of the present disclosure.

The passkey management method according to another embodiment of the present disclosure may be executed by the passkey provider server 1 illustrated in FIG. 1 or a computing device 100 illustrated in FIG. 16. The computing device 100 executing the passkey management method according to another embodiment of the present disclosure may be a computing device equipped with an application program execution environment. The computing device 100 may be, for example, an application server, a cloud server, or a virtual server.

Descriptions of a subject entity that performs operations or steps included in the passkey management method according to another embodiment of the present disclosure may be omitted. In such cases, the subject entity is to be understood as the computing device 100.

In providing a passkey management service, the passkey management method according to another embodiment of the present disclosure may share information regarding a passkey registered on Windows OS so that it can be viewed on other OS platforms.

Referring to FIG. 4, when the computing device 100 receives information regarding a first passkey that has been generated and registered by a first terminal 21 based on a first platform, in step S100, the computing device 100 updates the registered passkey list in step S200. Here, the first platform may be, for example, Windows OS.

Thereafter, in step S300, when the computing device 100 receives a passkey list request from a passkey agent installed on a second terminal 22 based on a second platform different from the first platform, the computing device 100 provides information regarding the updated passkey list to the second terminal 22. The second platform may be, for example, Android or iOS.

At this time, the computing device 100 may provide, to the passkey agent of the second terminal 22, information indicating whether each passkey included in the updated passkey list is for multiple platforms or for a specific platform. In addition, the computing device 100 may further provide information indicating whether each passkey included in the updated passkey list is in a synced state or a desynced state.

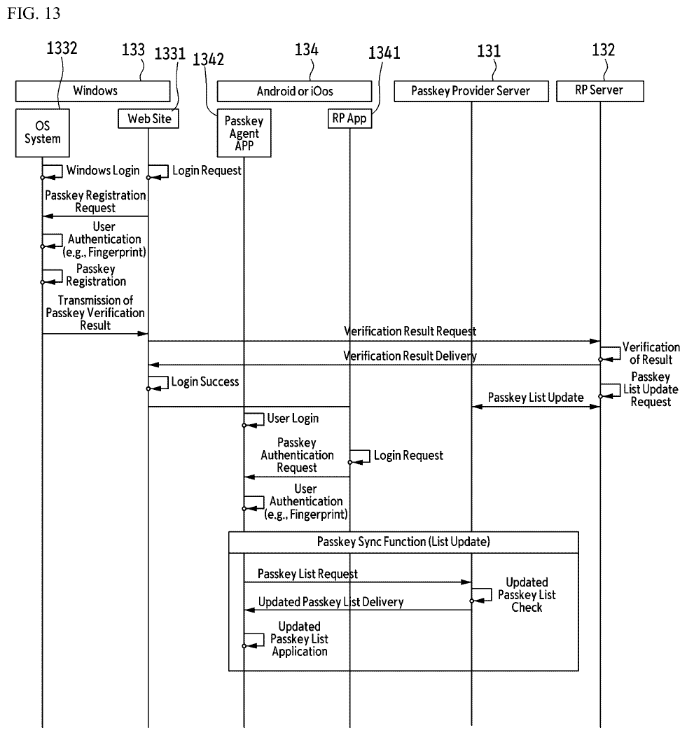

As a specific example, referring to FIG. 13, when there is a login request from a website 1331 through a browser after logging into Windows OS 1332 on a Windows OS-based first terminal 133, a passkey authentication request is sent to the Windows OS 1332.

Accordingly, the Windows OS 1332 performs user authentication through biometric recognition such as fingerprint recognition, directly generates and registers a passkey, and transmits the passkey registration result to an RP server 132 for verification.

The website 1331 of the first terminal 134 receives the verification result from the RP server 132, and login is successfully performed accordingly.

Meanwhile, the RP server 132 sends a passkey list update request using the passkey registration result received from the Windows OS 1332, and accordingly, the passkey provider server 131 updates the registered passkey list.

Thereafter, when a passkey agent 1342 of an Android- or iOS-based second terminal 134 receives a passkey authentication request in response to a login request from an RP application 1341 after user login, the passkey agent 1342 performs user authentication through biometric recognition and sends a passkey list request to the passkey provider server 131.

The passkey provider server 131 provides the passkey agent 1342 of the second terminal 134 with the passkey list updated using the passkey registration result received from the Windows OS 1332 of the first terminal 133. Accordingly, the passkey agent 1342 displays the updated passkey list including the passkey registered on the Windows OS 1332 of the first terminal 133.

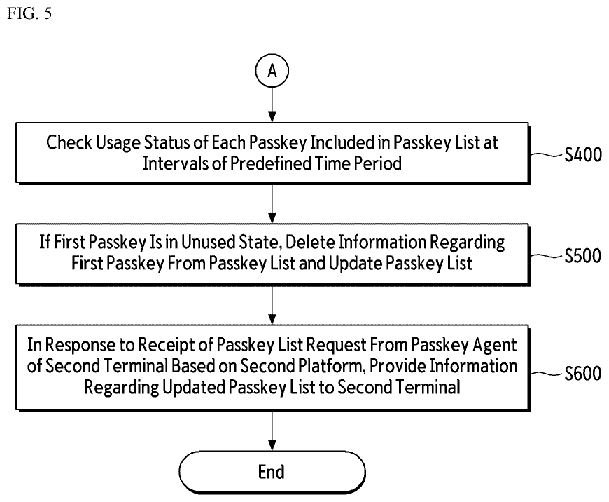

As one embodiment, referring to FIG. 5, after performing steps S100, S200, and S300 of FIG. 4, the computing device 100 may additionally perform steps S400, S500, and S600.

In step S400, the computing device 100 periodically checks the usage status of each passkey in the registered passkey list at intervals of a predefined time period, and in step S500, if the result shows that the first passkey is in an unused state, the computing device 100 deletes information on the first passkey from the registered passkey list, thereby updating the registered passkey.

Thereafter, in step S600, when the computing device 100 receives a passkey list request from the passkey agent of the second terminal based on the second platform, the computing device 100 may provide the updated passkey list to the second terminal.

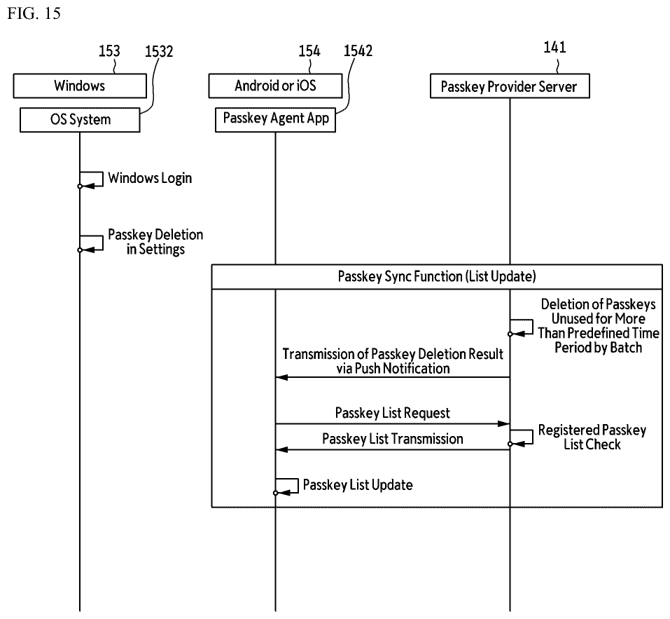

As a specific example, referring to FIG. 15, after login to Windows OS 1532 on a Windows OS-based first terminal 153, a specific passkey stored and registered on the Windows OS 1532 may be deleted.

A passkey provider server 141 checks, in batch, whether there are any passkeys that have not been used for more than a certain period of time, and may identify the unused passkeys. For example, by checking the presence of any unused passkeys, the passkey provider server 141 may identify that the specific passkey has been deleted from the Windows OS 1532 of the first terminal 153.

Accordingly, the passkey provider server 141 may update the registered passkey list by deleting the specific passkey that has not been used for more than the certain period of time, and transmit the passkey deletion result to a passkey agent 1542 of an Android- or iOS-based second terminal 154 as a push notification.

The passkey agent 1542 of the second terminal 154 may send a passkey list request to the passkey provider server 141, and the passkey provider server 141 may transmit the updated passkey list with the specific passkey deleted to the passkey agent 1542. Accordingly, the passkey agent 1542 may display the updated passkey list.

According to the aforementioned embodiment, information regarding a passkey that is registered or deleted on Windows OS can also be shared with, and viewed on, other OS platforms.

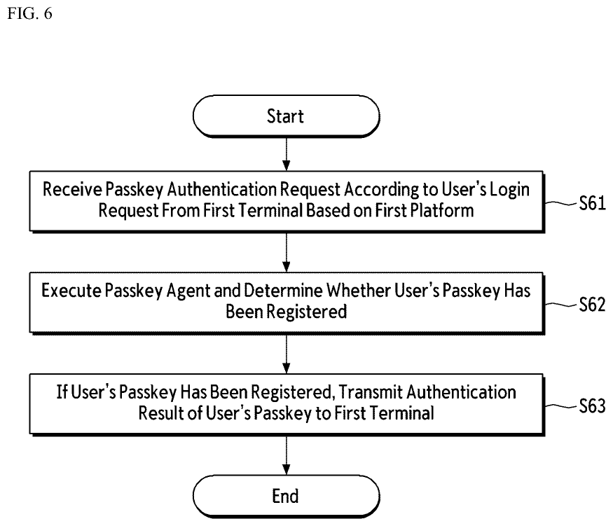

FIG. 6 is a flowchart illustrating a passkey management method for a multi-platform environment according to yet another embodiment of the present disclosure.

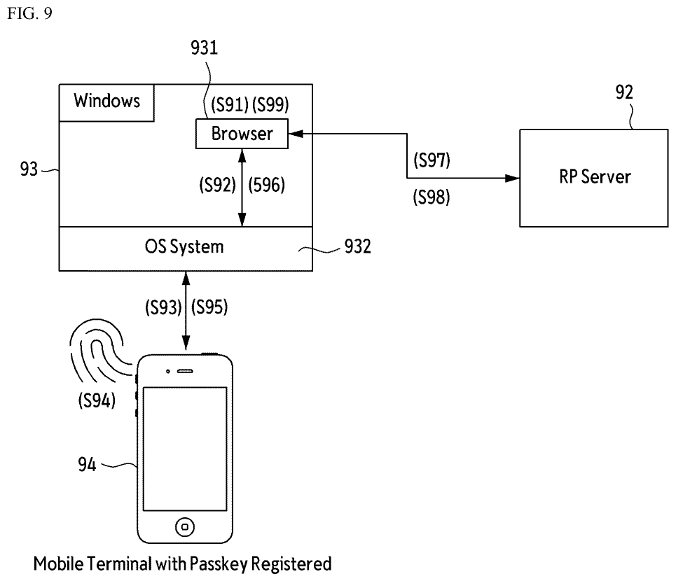

The passkey management method according to yet another embodiment of the present disclosure may be executed by a mobile terminal 94 illustrated in FIG. 9. Here, the mobile terminal 94 may be a user terminal based on Android or iOS. The mobile terminal 94 that executes the passkey management method according to yet another embodiment of the present disclosure may be, for example, a smartphone or tablet.

Descriptions of a subject entity that performs some operations or steps included in the passkey management method according to yet another embodiment of the present disclosure may be omitted. In such cases, the subject entity is to be understood as the mobile terminal 94.

According to the passkey management method according to yet another embodiment of the present disclosure, when a public PC with a potential security threat is used, a user may safely access a website or service application on the public PC by using a multi-platform passkey previously stored on the user's own mobile terminal.

Referring to FIG. 6, in step S61, the mobile terminal 94 receives a passkey authentication request in response to the user's login request from a first terminal 93 based on Windows OS (“93” in FIG. 9). Here, the mobile terminal 94 may be a user terminal based on Android or iOS.

For example, the mobile terminal 94 may receive a user authentication request and a passkey authentication request in response to the user's login request for a specific website via a browser installed on the first terminal 93.

Thereafter, in step S62, the mobile terminal 94 executes a passkey agent to determine whether the user's passkey has already been registered. In step S63, if the user's passkey is determined to be already registered, the mobile terminal 94 transmits the authentication result of the user's passkey to the first terminal 93.

For example, when user authentication and passkey authentication are successfully performed on the mobile terminal 94 upon request from the first terminal 93, the authentication result of the user's passkey may be transmitted to the Windows OS of the first terminal 93.

FIG. 9 illustrates a process in which, in response to a request from a Windows OS-based terminal, a terminal based on another platform provides a passkey authentication result, with reference to FIG. 6.

Referring to FIG. 9, when a login attempt is made to a first site via a web browser 931 on a Windows OS-based first terminal 93 (S91), the first site sends a passkey authentication request to Windows OS 932 (S92).

Then, the Windows OS 932 sends a passkey authentication request to the mobile terminal 94 that has been registered (S93), and the mobile terminal 94 performs user authentication and passkey authentication using a passkey agent (S94). Here, the mobile terminal 94 may be a terminal based on Android or iOS, different from the Windows OS 932 of the first terminal 93.

If passkey authentication is successfully performed using a pre-registered multi- platform passkey, the mobile terminal 94 transmits the passkey authentication result to the Windows OS 932 of the first terminal 93 (S95). The multi-platform passkey may be in a synced state and usable across various OS platforms.

The Windows OS 932 transmits the passkey authentication result to the web browser 931 (S96), and the web browser 931 sends a verification request for the passkey authentication result to an RP server 92 (S97).

The RP server 92 returns the verification result of the multi-platform passkey to the web browser 931 (S98), and when the web browser 931 completes verification of the received verification result, login to the first site is successfully performed (S99).

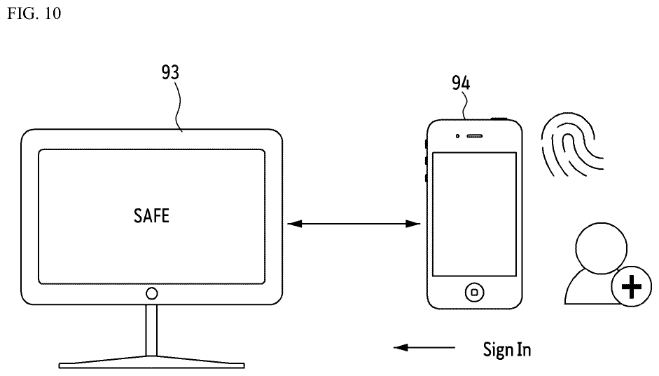

According to the aforementioned embodiment, as illustrated in FIG. 10, when the first terminal 93, such as a public PC in a library or an internet café, is used where a security threat may be a concern, the user can use a multi-platform passkey securely stored in their own mobile terminal 94 (either Android or iOS) to safely access desired sites or game applications without the risk of exposing personal information such as passwords.

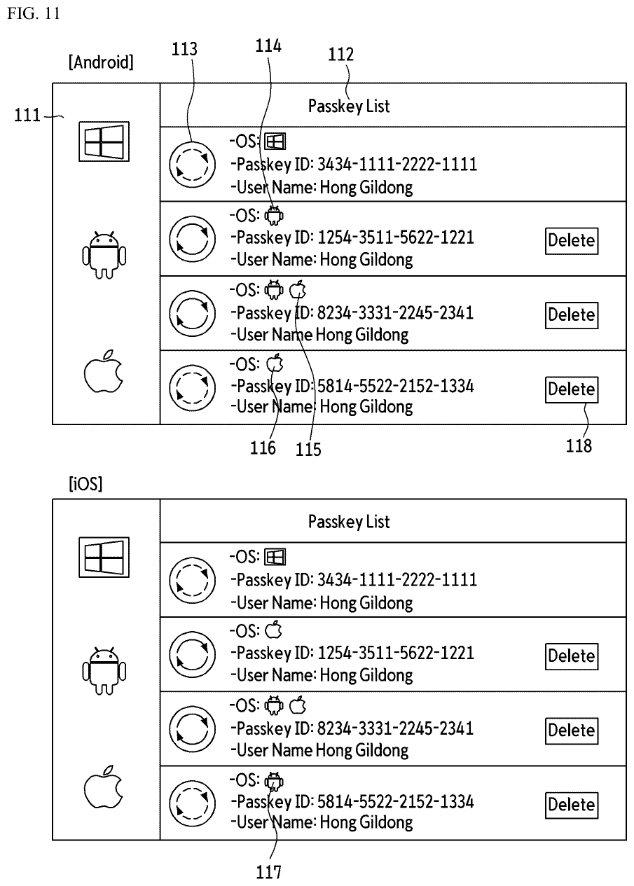

FIG. 11 illustrates an exemplary management screen interface provided by a passkey agent according to some embodiments of the present disclosure.

Specifically, FIG. 11 illustrates the management screen of a passkey agent installed on an Android- or iOS-based terminal that provides a passkey service.

On the management screen of the passkey agent, passkeys can be viewed not only for the OS platform of the corresponding terminal but also for various other OS platforms such as Windows OS, Android, and iOS.

The management screen of the passkey agent displays a passkey list 112 that includes passkeys registered with the passkey provider server 1.

In one embodiment, the passkey list 112 may display all passkeys registered on terminals of various OS platforms and may also display information 113 indicating whether each passkey is in a synced or desynced state. The synchronization status of each passkey may be visually distinguished using specific icons or colors.

For example, in the case of Windows OS, since passkeys are not generated and synced by the passkey provider server 1 but rather stored and managed within Windows OS itself, they may be viewable only in the passkey list 112 and may be marked as being in a desynced state.

In one embodiment, the passkey list 112 may display all passkeys registered on terminals of various OS platforms and information 113 indicating whether each passkey is in a synced or desynced state.

In one embodiment, the passkey list 112 may display whether each passkey registered on terminals of various OS platforms is for multi-platform use 115 or for single-platform use 114.

For example, when a passkey is requested to be registered on an Android- or iOS-based terminal, it may be requested to be registered with a selected option for either multi-platform or single-platform use.

Accordingly, passkeys registered for multi-platform use may be marked as being in a synced state in the passkey list 112 displayed on the management screen of the passkey agent because they are usable across multiple OS platforms.

Conversely, passkeys registered for single-platform use may only be available on the platform on which they have been registered, and may thus be marked as being in a desynced state for other OS platforms.

On the passkey agent of an Android-based terminal, a passkey registered on the same Android platform 114 may be displayed as being in a synced state, whereas a passkey registered on a different platform such as iOS 116 may be displayed as being in a desynced state. For example, a green circular icon may be used to indicate a synced state and a red circular icon to indicate a desynced state. Alternatively, a solid arrow within a circular icon may indicate a synced state, and a dotted arrow within the circular icon may indicate a desynced state. In this manner, the synchronization status of each passkey may be identifiable through various user interface elements.

Additionally, in the passkey agent of an iOS-based terminal, a passkey registered on Android 117 for single-platform use may be displayed as being in a desynced state since it is not usable on iOS.

In one embodiment, each passkey marked as multi-platform use in the passkey list 112 may be changed to single-platform use. This change may be performed via an administrator portal of the passkey provider server 1 or through the passkey agent on the terminal where the corresponding passkey has been registered. When a passkey registered for multi-platform use is changed to single-platform use, its synchronization status displayed in the passkey list 112 may be changed from synced to desynced, and only the icon corresponding to the OS platform where the passkey is usable may be displayed.

In one embodiment, each passkey displayed in the passkey list 112 may be deletable. For example, a delete button 118 may be displayed to the right of each passkey in the passkey list 112, allowing for deletion by clicking the delete button 118.

When the delete button 118 is clicked, the passkey agent of the terminal sends a deletion request to the passkey provider server 1, which then performs deletion processing for the corresponding stored passkey.

If deletion of the corresponding stored passkey is successfully completed by the passkey provider server 1, the deletion result is transmitted to the passkey agent of the terminal where the passkey has been registered, and the corresponding stored passkey is deleted accordingly.

According to the aforementioned embodiment, an integrated management function using the passkey agent can be provided, allowing for viewing and deletion of passkeys registered on different platforms through a single screen.

FIG. 16 is a hardware configuration diagram of an exemplary computing device 100.

Referring to FIG. 16, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

In one embodiment, the computer program 105 may include instructions for performing the operations of: in response to receipt of a passkey generation request from a passkey agent installed on a first terminal based on a first platform, generating a first passkey usable on multiple platforms, and transmitting the first passkey to the first terminal; in response to receipt of a passkey list request from a passkey agent installed on a second terminal based on a second platform, different from the first platform, providing information regarding a registered passkey list to the second terminal; and in response to receipt of a request for the first passkey from the passkey agent of the second terminal, transmitting the first passkey to the second terminal.

In another embodiment, the computer program 105 may include instructions for performing the operations of: in response to receipt of information regarding a first passkey generated and registered by a first terminal based on a first platform, updating a registered passkey list using the information regarding the first passkey; and in response to receipt of a passkey list request from a passkey agent installed on a second terminal based on a second platform, different from the first platform, providing the updated passkey list to the second terminal.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A passkey management method for a multi-platform environment, performed by a computing device, comprising:
in response to receipt of a passkey generation request from a passkey agent installed on a first terminal based on a first platform, generating a first passkey usable on multiple platforms, and transmitting the first passkey to the first terminal;
in response to receipt of a passkey list request from a passkey agent installed on a second terminal based on a second platform, different from the first platform, providing information regarding a registered passkey list to the second terminal; and
in response to receipt of a request for the first passkey, among passkeys included in the registered passkey list, from the passkey agent of the second terminal, transmitting the first passkey to the second terminal.

2. The passkey management method of claim 1, wherein the first and second platforms are different OS platforms.

3. The passkey management method of claim 1, wherein the generating and transmitting of the first passkey comprises receiving the passkey generation request from the passkey agent of the first terminal upon completion of user authentication by the passkey agent of the first terminal in response to a login request from a first service application installed on the first terminal.

4. The passkey management method of claim 1, wherein the providing of the information regarding the registered passkey list comprises receiving the passkey list request from the passkey agent of the second terminal upon completion of user authentication by the passkey agent of the second terminal in response to a login request from a first service application installed on the second terminal.

5. The passkey management method of claim 1, wherein the providing of the information regarding the registered passkey list comprises providing, to the passkey agent of the second terminal, information indicating whether each of the passkeys included in the registered passkey list is for multi-platform use or for specific platform use.

6. The passkey management method of claim 1, wherein the providing of the information regarding the registered passkey list comprises providing, to the passkey agent of the second terminal, information indicating whether each of the passkeys included in the registered passkey list is in a synced state or a desynced state.

7. The passkey management method of claim 6, wherein the providing of the information indicating whether each of the passkeys included in the registered passkey list is in the synced state or the desynced state, comprises providing additional information indicating a synchronization status of each passkey usable on both the first and second platforms.

8. The passkey management method of claim 6, wherein the providing of the information indicating whether each of the passkeys included in the registered passkey list is in the synced state or the desynced state comprises providing additional information indicating that each passkey that is exclusive to Windows OS or usable only on the first platform is in the desynced state.

9. The passkey management method of claim 1, further comprising:
providing information regarding the registered passkey list to the first terminal;
receiving, from the passkey agent of the first terminal, a deletion request for a second passkey among the passkeys included in the registered passkey list;
updating the registered passkey list by deleting the second passkey; and
providing information regarding the updated passkey list to the second terminal.

10. A passkey management method for a multi-platform environment, performed by a computing device, comprising:
in response to receipt of information regarding a first passkey that has been generated and registered by a first terminal based on a first platform, updating a registered passkey list using the information regarding the first passkey; and
in response to receipt of a passkey list request from a passkey agent installed on a second terminal based on a second platform, different from the first platform, providing information regarding the updated passkey list to the second terminal.

11. The passkey management method of claim 10, wherein
the first platform is Windows OS, and
the second platform is an OS platform different from the Windows OS.

12. The passkey management method of claim 10, wherein the providing of the information regarding the updated passkey list comprises providing, to the passkey agent of the second terminal, information indicating whether each passkey included in the updated passkey list is for multi-platform use or for specific platform use.

13. The passkey management method of claim 10, wherein the providing of the information regarding the updated passkey list comprises providing, to the passkey agent of the second terminal, information indicating whether each passkey included in the updated passkey list is in a synced state or a desynced state.

14. The passkey management method of claim 10, comprising:
checking, at intervals of a predefined time period, whether each passkey included in the updated passkey list is in an unused state;
if the checking result shows that the first passkey is in the unused state, updating the registered passkey list by deleting the information regarding the first passkey from the passkey list; and
providing information regarding the updated passkey list to the passkey agent of the second terminal.

15. The passkey management method of claim 14, further comprising:
transmitting a push notification of a deletion result of the first passkey to the passkey agent of the second terminal.

16. A passkey management method for a multi-platform environment, performed by a user terminal based on a second platform, comprising:
receiving, from a first terminal based on a first platform different from the second platform, a passkey authentication request in response to a user's login request;
executing a passkey agent installed on the user terminal to determine whether the user's passkey has been previously registered; and
if the user's passkey is determined to have been previously registered, transmitting an authentication result of the user's passkey to the first terminal.

17. The passkey management method of claim 16, wherein
the first platform is Windows OS, and
the second platform is an OS platform different from the Windows OS.

18. The passkey management method of claim 16, wherein the receiving of the passkey authentication request from the first terminal comprises receiving a user authentication request and the passkey authentication request in response to the user's login request for a specific website via a browser installed on the first terminal.

19. The passkey management method of claim 18, wherein the transmitting of the authentication result of the user's passkey to the first terminal comprises, if user authentication and passkey authentication for the user are successfully performed, transmitting the authentication result of the user's passkey to the first platform.

20. A computing device comprising:
at least one processor;
a memory that loads a computer program executed by the at least one processor; and
a storage that stores the computer program,
wherein the computer program includes instructions for performing operations of: in response to receipt of a passkey generation request from a passkey agent installed on a first terminal based on a first platform, generating a first passkey usable on multiple platforms and transmitting the first passkey to the first terminal; in response to receipt of a passkey list request from a passkey agent installed on a second terminal based on a second platform, different from the first platform, providing information regarding a registered passkey list to the second terminal; and in response to receipt of a request for the first passkey, among passkeys included in the registered passkey list, from the passkey agent of the second terminal, transmitting the first passkey to the second terminal.
